(19) United States
(12) Patent Application Publication
(10) Pub. No.: US 2023/0259970 A1
(43) Pub. Date: Aug. 17, 2023

(54) CONTEXT BASED ADVERTISEMENT PREDICTION

(71) Applicant: Pinterest, Inc., San Francisco, CA (US)

(72) Inventors: Jinyin Zhang, Mountain View, CA (US); Liangzhe Chen, Belmont, CA (US); Jiajing Xu, Palo Alto, CA (US)

(21) Appl. No.: 17/673,613

(22) Filed: Feb. 16, 2022

(51) Int. Cl. G06Q 30/02; G06N 3/04; G06N 3/08

(52) U.S. Cl. CPC G06Q 30/0246; G06N 3/0481; G06N 3/0454; G06N 3/08

(57) ABSTRACT

Described are systems and methods to determine advertisements to be presented to a user. To determine the advertisements to be presented to the user, the described systems and methods utilize localized contextual information to select the advertisements and the relative positioning of the advertisements to be presented, so as to select and present more relevant advertisements based on the content that is surrounding and proximate to the presentation of the selected advertisements.

### BACKGROUND

Advertisements are encountered nearly everywhere in online content. Advertisements are common on nearly all webpages, mobile applications, social media platforms, etc. Because of the ubiquitous nature of online advertisements, the effectiveness and/or value of advertisements can sometimes be questionable. The ineffectiveness of advertisements can also be magnified if unrelated and/or irrelevant advertisements are presented relative to the non-advertisement content being presented.

### BRIEF DESCRIPTION OF THE DRAWINGS

FIG. 1 is an illustration of an exemplary computing environment, according to exemplary embodiments of the present disclosure.

FIGS. 2A and 2B are illustrations of exemplary user interfaces, according to exemplary embodiments of the present disclosure.

FIG. 3 is a block diagram of an exemplary advertisement determination model, according to exemplary embodiments of the present disclosure.

FIG. 4 is a flow diagram of an exemplary deep neural network training process, according to exemplary embodiments of the present disclosure.

FIG. 5 is flow diagram of an exemplary advertisement determination process, according to exemplary embodiments of the present disclosure.

FIG. 6 is a flow diagram of an exemplary deep neural network update process, according to exemplary embodiments of the present disclosure.

FIG. 7 is an illustration of an exemplary client device, according to exemplary embodiments of the present disclosure.

FIG. 8 is an illustration of an exemplary configuration of a client device, such as that illustrated in FIG. 7, according to exemplary embodiments of the present disclosure.

FIG. 9 is an illustration of an exemplary remote computing resource, according to exemplary embodiments of the present disclosure.

### DETAILED DESCRIPTION

As is set forth in greater detail below, embodiments of the present disclosure are generally directed to systems and methods for determining advertisements to be presented to a user. In addition to identifying the advertisements to be presented to the user, embodiments of the present disclosure can also determine a relative positioning of the advertisement within the user interface presented to the user. Embodiments of the present disclosure utilize localized contextual information to select the advertisements and the relative positioning of the advertisements to be presented so as to select and present more relevant advertisements based on the content that is surrounding and proximate to the presentation of the selected advertisements.

According to exemplary embodiments of the present disclosure, one or more deep neural networks (“DNN”), or other machine learning models, may be trained to process various input information and parameters to determine relevance scores associated with each candidate advertisement. For example, the trained DNN may include two independent components/towers within the trained DNN. The first component/tower of the DNN may be trained to process general quality information and/or parameters, such as user history, a query, and the like, to generate an advertisement quality relevance score associated with each candidate advertisement. The second component/tower of the DNN may be trained to process local contextual information, such as predefined ad position (e.g., slot index, column, etc.), surrounding advertisement content, surrounding non-advertisement content, advertisement format, and the like, to generate an advertisement contextual relevance score associated with each candidate advertisement. The advertisement quality relevance score and the advertisement contextual relevance score may be aggregated to determine an overall advertisement engagement score, which may represent an overall relevance of the advertisement (e.g., likelihood that the user will interact or otherwise engage with the advertisement, etc.). Accordingly, advertisements from the candidate advertisements may be presented to the user based on the associated overall advertisement engagement scores. For example, the candidate advertisements may be ranked according to their associated overall advertisement engagement scores for each predefined ad position, and the candidate advertisements with the highest overall advertisement engagement score for each predefined ad position may be presented to the user.

According to exemplary embodiments of the present disclosure, co-training a single DNN with two independent components/towers simplifies training, development, and maintenance of the DNN. Further, in view of the two independent components/towers, the input information and parameters may be served and processed in parallel, so as to mitigate the introduction of additional latency. Further, exemplary implementations may also utilize cached content items as an approximation of contextual content to further mitigate latency issues that may result from using actual contextual content.

Additionally, after the advertisements have been determined and presented to the user (e.g., at the predefined ad locations), the performance of the presented advertisements at the predefined ad locations may be tracked. For example, click through rates associated with each advertisement may be determined, and based on the click through rates, feedback training data may be generated to continuously update the trained DNN to improve the performance and accuracy of the trained DNN.

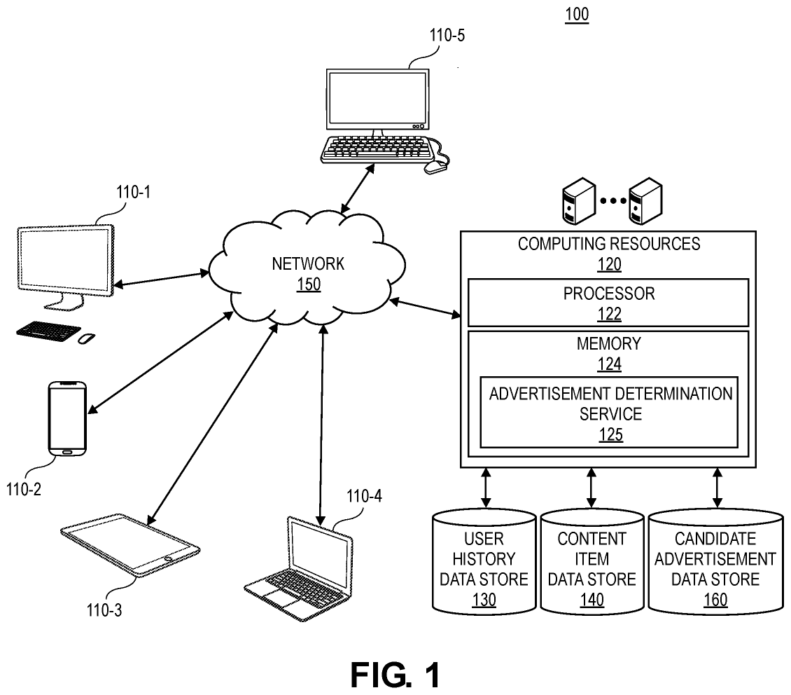

FIG. 1 is an illustration of an exemplary computing environment 100, according to exemplary embodiments of the present disclosure.

As shown in FIG. 1, computing environment 100 may include one or more client devices 110 (e.g., client devices 110-1, 110-2, 110-3, 110-4, and 110-5), remote computing resources 120, and advertisement determination service 125, which may execute on remote computing resources 120. Remote computing resources 120 may include one or more processors 122 and one or more memory 124. Further, remote computing resources 120 may also include one or more applications, such as advertisement determination service 125, that may be executed by processor(s) 122 to cause the processor(s) 122 of remote computing resources 120 to perform various functions and/or actions. Advertisement determination service 125 may include one or more deep neural networks (“DNN”) that have been trained to determine one or more advertisements, as well as relative positioning of the advertisements, to be presented to a user on any of client devices 110-1, 110-2, 110-3, 110-4, and/or 110-5. In other implementations, portions of the disclosed implementations may be performed on client devices 110-1, 110-2, 110-3, 110-4, and 110-5. As will be appreciated, any variation of processing and/or other operations of the disclosed implementations may be performed on one or many different devices. Likewise, the disclosed implementations, may, for example, be provided as part of a social networking environment, e-commerce environment, or any other form of interactive computing. Further, remote computing resources 120 do not require end-user knowledge of the physical location and configuration of the system that delivers the services. Common expressions associated with these remote computing resources 120 include, for example, “on-demand computing,” “software as a service (SaaS),” “platform computing,” “network-accessible platform,” “cloud services,” “data centers,” and so forth.

Each client device 110-1, 110-2, 110-3, 110-4 and 110-5 and remote computing resources 120 may communicate via wired and/or wireless connections to network 150. Client devices 110-1, 110-2, 110-3, 110-4 and/or 110-5 may include any type of computing device, such as a smartphone, tablet, laptop computer, desktop computer, wearable, etc., and network 150 may include any wired or wireless network (e.g., the Internet, cellular, satellite, Bluetooth, Wi-Fi, etc.) that can facilitate communications between client devices 110-1, 110-2, 110-3, 110-4 and 110-5 and remote computing resources 120 (and advertisement determination service 125 executing thereon).

Further, advertisement determination service 125 may be configured to be in communication with user history data store 130, content item data store 140, and candidate advertisement data store 160. User history data store 130 may be configured to store and maintain information associated with one or more users associated with client devices 110-1, 110-2, 110-3, 110-4 and/or 110-5. For example, this can include information relating to the user's profile and/or history (e.g., demographic information, user preferences, level of activity, type of activity, content items associated with the user, queries associated with the user, subscriptions, purchase history, click through history, etc.). Additionally, content item data store 140 may be configured to store and maintain various content items (e.g., images, videos, etc.), and candidate advertisement data store 160 may be configured to store and maintain candidate advertisements that are available to be presented to the user on client devices 110-1, 110-2, 110-3, 110-4 and/or 110-5.

According to exemplary embodiments of the present disclosure, client devices 110-1, 110-2, 110-3, 110-4 and/or 110-5 may access and/or interact with advertisement determination service 125 through network 150 via one or more applications operating and/or executing on client devices 110-1, 110-2, 110-3, 110-4 and/or 110-5. In exemplary implementations, users associated with client devices 110-1, 110-2, 110-3, 110-4, and/or 110-5 may be navigating, viewing, accessing, and/or otherwise consuming content items on client devices 110-1, 110-2, 110-3, 110-4, and/or 110-5 as part of a social media platform or environment, a networking platform or environment, an e-commerce platform or environment, by performing queries, or through any other form of interactive computing. In connection with the consumption of content items on client devices 110-1, 110-2, 110-3, 110-4, and/or 110-5, a request for one or more advertisements may accompany or be included in the user's navigation and/or consumption of content items so that advertisements may be selected and presented alongside the content items. The user interfaces presenting the content items and the advertisements may include one or more predefined ad positions (e.g., defined by slot and/or column, etc.) at which advertisements may be presented. Accordingly, the selected advertisements may be presented to users via user interface(s) presented on client devices 110-1, 110-2, 110-3, 110-4, and/or 110-5 at the predefined ad positions during consumption of the content items.

In response to the request for one or more advertisements, advertisement determination service 125 may obtain various information and parameters (e.g., from user history data store 130, content item data store 140, etc.) associated with the user and the user's activities and one or more candidate advertisements (e.g., from candidate advertisement data store 160, etc.), from which the advertisements to be presented may be selected. The obtained information and parameters may be processed to determine one or more advertisements to be presented to the user, as well as an ad position at which the selected advertisements may be presented. According to exemplary implementations, the obtained information and parameters may include general quality information and/or parameters, such as user history, a query, and the like, and local contextual information and/or parameters, such as an ad position (e.g., slot index, column, etc.), surrounding advertisement content, surrounding non-advertisement content, advertisement format, and the like. The general quality of information and/or parameters may be processed by advertisement determination service 125 to generate an advertisement quality relevance score for each candidate advertisement, and the local contextual information may be processed by advertisement determination service 125 to determine an advertisement contextual relevance score for each candidate advertisement.

According to exemplary implementations of the present disclosure, advertisement determination service 125 may include one or more trained DNNs to process the obtained information and parameters to determine the one or more advertisements to be presented to the user, as well as an ad position at which the selected advertisements may be presented. The trained DNN may include two independent components/towers, where the first component/tower is configured to process the general quality information and/or parameters to determine an advertisement quality relevance score associated with each candidate advertisement, and the second component/tower of the DNN is configured to process the local contextual information and/or parameters to determine an advertisement contextual relevance score for each candidate advertisement. According to certain aspects, determination of the advertisement quality relevance score and the advertisement contextual relevance score may be determined in parallel.

Next, for each candidate advertisement, an overall advertisement engagement score may be determined based on the advertisement quality relevance score and the advertisement contextual relevance score. For example, the overall advertisement engagement score may be determined using a sigmoid function on the aggregation of the advertisement quality relevance score and the advertisement contextual relevance score. Accordingly, the overall advertisement engagement score may be represented as:

Overall Relevance Score=Sigmoid (Ad_Quality+Ad_Context)

where Ad_Quality may represent the advertisement quality relevance score and Ad_Context may represent the advertisement contextual relevance score. After the overall advertisement engagement score has been determined, the advertisements to be presented to the user may be determined for each predefined ad position within the user interface that is presented to the user on client devices 110-1, 110-2, 110-3, 110-4, and/or 110-5 based on the overall advertisement engagement scores associated with each candidate advertisement. For example, the candidate advertisement with the highest overall advertisement engagement score for each predefined ad position may be selected and presented to the user at each the predefined ad position. Further, the performance of each selected and presented advertisement may be monitored (e.g., click-through rate, etc.) and feedback training data may be generated based on the actual monitored performance to further update and improve the performance of the DNN.

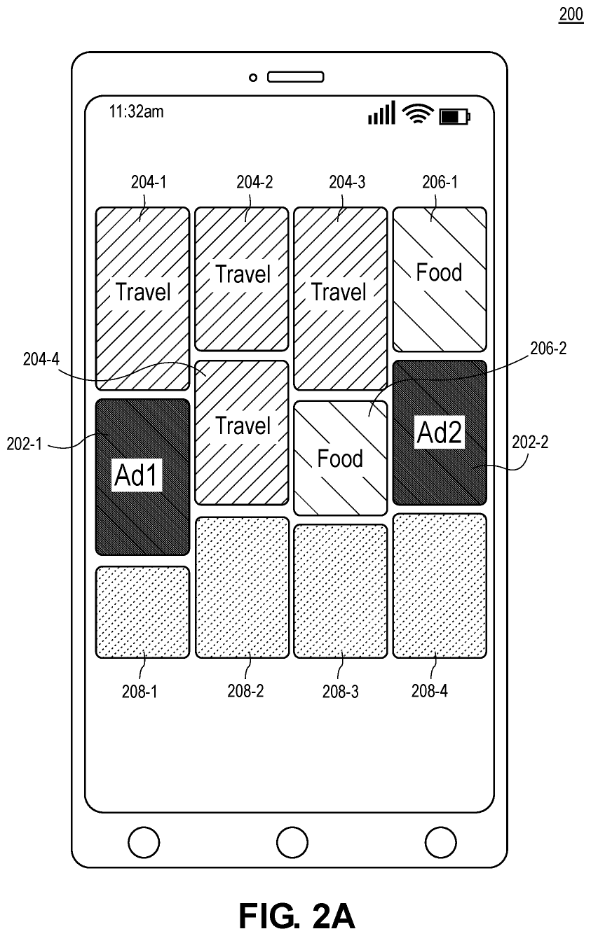

FIGS. 2A and 2B illustrate exemplary user interfaces presenting content items and advertisements, according to exemplary embodiments of the present disclosure.

FIG. 2A is a block diagram illustration of exemplary user interface 200, according to exemplary embodiments of the present disclosure. User interface 200 may represent a user interface presented to users on client devices (e.g., client devices 110-1, 110-2, 110-3, 110-4, and/or 110-5) as users are navigating, viewing, accessing, and/or otherwise consuming content items as part of a social media platform or environment, a networking platform or environment, an e-commerce platform or environment, by performing queries, or through any other form of interactive computing.

As shown in FIG. 2A, user interface 200 may include content items 204-1, 204-2, 204-3, 204-4, 206-1, and 206-2. Content items 204-1, 204-2, 204-3, 204-4, 206-1, and 206-2 are non-advertisement content items and may be presented on user interface 200 for the user to view, access, or otherwise consume, in response to a query provided by the user, and the like. Additionally, user interface 200 may also include predefined ad positions 202-1 and 202-2, at which candidate advertisements determined and selected according to exemplary embodiments of the present disclosure may be presented.

Exemplary embodiments of the present disclosure may determine and select advertisements, from a plurality of candidate advertisements, to be presented at predefined ad positions 202-1 and 202-2. In determining the advertisements to be presented at predefined ad positions 202-1 and 202-2, various inputs may be provided to a trained DNN (e.g., advertisement determination service 125) to predict an overall advertisement engagement score, which can be used to determine the advertisements to be presented at predefined ad positions 202-1 and 202-2.

For example, advertisement quality parameters and advertisement contextual parameters may be provided as inputs to the trained DNN to predict overall advertisement engagement scores for each candidate advertisement, to determine which of the candidate advertisements may be presented at predefined ad positions 202-1 and 202-2. The advertisement quality parameters may include information such as a query submitted by the user, user profile information, user preferences, user browsing history, user tastes, user likes/dislikes, content items associated with the user, demographic information, user activity, user subscriptions, queries performed by the user, and the like, and be provided as an input to a first independent component/tower of the trained DNN. The first component/tower of the trained DNN can process the advertisement quality parameters to generate a predicted advertisement quality relevance score for each candidate advertisement. The predicted advertisement quality relevance score may represent a predicted click-through rate, revenue per recipient, or other metric based on the user information.

Additionally, the advertisement contextual parameters may include information such as the position of the advertisement to be presented (e.g., predefined ad positions 202-1 and/or 202-2.), information regarding the non-advertisement content surrounding and/or in close proximity of the advertisement to be presented, information regarding the advertisement content surrounding and/or in close proximity of the advertisement to be presented, information regarding the content of the candidate advertisement, and the like, and be provided as an input to a second independent component/tower of the trained DNN. The second component/tower of the trained DNN can process the advertisement contextual parameters to generate a predicted advertisement contextual relevance score for each candidate advertisement. The predicted advertisement contextual relevance score may represent a predicted click-through rate, revenue per recipient, or other metric based on the localized contextual information.

In the exemplary implementation illustrated in FIG. 2A, in connection with predefined ad position 202-1, the advertisement contextual parameters provided to the trained DNN may include information associated with content items 204-1, 204-2, 204-3, and/or 204-4, which surround and/or are in close proximity to predefined ad position 202-1, information associated with an advertisement presented at predefined ad position 202-2, and the like. Advertisement contextual parameters may also include information associated with each candidate advertisement, such as content information, format information (e.g., a logo advertisement, a price drop/sale advertisement, a flickering advertisement, etc.), and the like. For example, the advertisement contextual parameters may include one or more embedding vectors associated with each content item 204-1, 204-2, 204-3, and/or 204-4, which may represent certain aspects (e.g., content type, content category, image information, source/location information, content/image features, metadata associated with the content item, etc.) of each corresponding content item 204-1, 204-2, 204-3, and/or 204-4, one or more embedding vectors associated with the advertisement presented at predefined ad position 202-2, which may represent certain aspects (e.g., advertisement type, advertisement category, advertisement format, advertisement image information, source/location information, advertisement/image features, metadata associated with the advertisement item, etc.) of the advertisement presented at predefined ad position 202-2. Further, the advertisement contextual parameters may also include embedding vectors associated with each candidate advertisement, which may represent certain aspects (e.g., content type, content category, image information, source/location information, metadata associated with the content item, etc.) of each corresponding candidate advertisement. According to certain aspects of the present disclosure, the embedding vectors associated with content items 204-1, 204-2, 204-3, and/or 204-4 and/or the advertisement presented at predefined ad position 202-2 may be compared with the embedding vectors of each candidate advertisement to determine a similarity metric between the surrounding non-advertisement content items (e.g., content items 204-1, 204-2, 204-3, and/or 204-4) and/or the advertisement presented at predefined ad position 202-2 and each candidate advertisement. For example, the similarity metric may be determined (e.g., averaging the vectors, utilizing a max pooling algorithm, utilizing a cosine similarity algorithm, utilizing a clustering algorithm, etc.), and the similarity metric may be provided as an input to the second component/tower of the trained DNN to determine a predicted advertisement contextual relevance score associated with each candidate advertisement.

Similarly, in connection with predefined ad position 202-2 illustrated in FIG. 2A, the advertisement contextual parameters provided to the trained DNN may include information associated with content items 206-1 and/or 206-2, which surround and/or are in close proximity to predefined ad position 202-2, information associated with an advertisement presented at predefined ad position 202-2, and the like. Advertisement contextual parameters may also include information associated with each candidate advertisement, such as content information, format information, and the like. For example, the advertisement contextual parameters may include one or more embedding vectors associated with each content item 206-1 and/or 206-2, which may represent certain aspects (e.g., content type, content category, image information, source/location information, content/image features, metadata associated with the content item, etc.) of each corresponding content item 206-1 and/or 206-2, one or more embedding vectors associated with the advertisement presented at predefined ad position 202-1, which may represent certain aspects (e.g., advertisement type, advertisement category, advertisement format, advertisement image information, source/location information, advertisement/image features, metadata associated with the advertisement item, etc.) of the advertisement presented at predefined ad position 202-1. Further, the advertisement contextual parameters may also include embedding vectors associated with each candidate advertisement, which may represent certain aspects (e.g., content type, content category, image information, source/location information, metadata associated with the content item, etc.) of each corresponding candidate advertisement. According to certain aspects of the present disclosure, the embedding vectors associated with content items 206-1 and/or 206-2 and/or the advertisement presented at predefined ad position 202-1 may be compared with the embedding vectors of each candidate advertisement to determine a similarity metric between the surrounding non-advertisement content items (e.g., content items 206-1 and/or 206-2) and/or the advertisement presented at predefined ad position 202-1 and each candidate advertisement. For example, the similarity metric may be determined (e.g., averaging the vectors, utilizing a max pooling algorithm, utilizing a cosine similarity algorithm, utilizing a clustering algorithm, etc.), and the similarity metric may be provided as an input to the second component/tower of the trained DNN to determine a predicted advertisement contextual relevance score associated with each candidate advertisement.

After the predicted advertisement quality relevance score and the predicted advertisement contextual relevance score have been determined, the two relevance scores may be combined and/or aggregated to determine a predicted overall advertisement engagement score for each candidate advertisement for each predefined ad position 202-1 and 202-2. For example, a Sigmoid function may be applied to the combination of the predicted advertisement quality relevance score and the predicted advertisement contextual relevance score to determine the predicted overall advertisement engagement score for each candidate advertisement. The predicted overall advertisement engagement score may represent a relevance of the advertisement and/or a likelihood that a user will engage with the advertisement, and may include, for example, a predicted click-through rate, revenue per recipient, or other metric based on both the advertisement quality information and the localized contextual information. Accordingly, the candidate advertisement with the highest predicted overall advertisement engagement score for predefined ad slot 202-1 may be selected as the advertisement to be presented in predefined ad slot 202-1, and the candidate advertisement with the highest predicted overall advertisement engagement score for predefined ad slot 202-2 may be selected as the advertisement to be presented in predefined ad slot 202-2.

FIG. 2B is an illustration of an exemplary user interface presenting advertisements determined according to exemplary embodiments of the present disclosure.

As shown in FIG. 2B, user interface 220 may include content items 222-1, 222-2, 222-3, 222-4, 222-5, and 222-6 and advertisements 224-1 and 224-2. Content items 222-1, 222-2, 222-3, 222-4, 222-5, and 222-6 are non-advertisement content items which may be presented on user interface 220 for the user to view, access, or otherwise consume, in response to a query provided by the user, and the like. Additionally, advertisements 224-1 and 224-2 may be advertisements that were determined and selected from a plurality of candidate advertisements according to exemplary embodiments of the present disclosure.

In the exemplary implementation illustrated in FIG. 2B, advertisements 224-1 and 224-2 may have been determined and selected, from a plurality of candidate advertisements, using a trained DNN (e.g., advertisement determination service 125).

For example, advertisement quality parameters and advertisement contextual parameters may have been provided as inputs to the trained DNN to predict overall advertisement engagement scores for each candidate advertisement in selecting and determining advertisements 224-1 and 224-2 for presentation to the user. The advertisement quality parameters may include information such as a query submitted by the user, user profile information, user preferences, user browsing history, user tastes, user likes/dislikes, content items associated with the user, demographic information, user activity, user subscriptions, queries performed by the user, and the like, and be provided as an input to a first independent component/tower of the trained DNN. The first component/tower of the trained DNN can process the advertisement quality parameters to generate a predicted advertisement quality relevance score for each candidate advertisement. The predicted advertisement quality relevance score may represent a predicted click-through rate, revenue per recipient, or other metric based on the user information.

Additionally, the advertisement contextual parameters may include information such as the position of the advertisement to be presented, information regarding the non-advertisement content surrounding and/or in close proximity of the advertisement to be presented, information regarding the advertisement content surrounding and/or in close proximity of the advertisement to be presented, information regarding the content of the candidate advertisement, and the like, and be provided as an input to a second independent component/tower of the trained DNN. The second component/tower of the trained DNN can process the advertisement contextual parameters to generate a predicted advertisement contextual relevance score for each candidate advertisement. The predicted advertisement contextual relevance score may represent a predicted click-through rate, revenue per recipient, or other metric based on the localized contextual information.

In the exemplary implementation illustrated in FIG. 2B, in connection with advertisement 224-1, the advertisement contextual parameters provided to the trained DNN may have included information associated with content items 222-1, 222-2, and/or 222-3, which surround and/or are in close proximity to advertisement 224-1, information associated with advertisement 224-2, and the like. As illustrated in the FIG. 2B, content items 222-1, 222-2, and/or 222-3 may relate to shoes, and advertisement 224-1, which may have been selected based on contextual information associated with content items 222-1, 222-2, and/or 222-3, may also relate to shoes. According to certain aspects, rather than obtain advertisement contextual parameters and information associated with the actual content items, cached content items may be utilized as an approximation of content items 222-1, 222-2, and/or 222-3, and the advertisement contextual parameters provided to the trained DNN may have included information associated with the cached content items.

Advertisement contextual parameters may also include information associated with each candidate advertisement, such as content information, format information, and the like. For example, the advertisement contextual parameters may include one or more embedding vectors associated with each content item 222-1, 222-2, and/or 222-3 (or a cached approximation thereof), which may represent certain aspects (e.g., content type, content category, image information, source/location information, content/image features, metadata associated with the content item, etc.) of each corresponding content item 222-1, 222-2, and/or 222-3 (or a cached approximation thereof), one or more embedding vectors associated with advertisement 224-2, which may represent certain aspects (e.g., advertisement type, advertisement category, advertisement format, advertisement image information, source/location information, advertisement/image features, metadata associated with the advertisement item, etc.) of advertisement 224-2. Further, the advertisement contextual parameters may also include embedding vectors associated with each candidate advertisement, which may represent certain aspects (e.g., content type, content category, image information, source/location information, metadata associated with the content item, etc.) of each corresponding candidate advertisement. According to certain aspects of the present disclosure, the embedding vectors associated with content items 222-1, 222-2, and/or 222-3 (or cached approximations thereof) and/or advertisement 224-2 may have been compared with the embedding vectors of each candidate advertisement to determine a similarity metric between the surrounding non-advertisement content items (e.g., content items 222-1, 222-2, and/or 222-3, or cached approximations thereof) and/or advertisement 224-2 and each candidate advertisement. For example, the similarity metric may be determined (e.g., averaging the vectors, utilizing a max pooling algorithm, utilizing a cosine similarity algorithm, utilizing a clustering algorithm, etc.), and the similarity metric may be provided as an input to the second component/tower of the trained DNN to determine a predicted advertisement contextual relevance score associated with each candidate advertisement.

Similarly, in connection with advertisement 224-2, the advertisement contextual parameters provided to the trained DNN may have included information associated with content items 222-4, 222-5, and/or 222-6, which surround and/or are in close proximity to advertisement 224-2, information associated with advertisement 224-2, and the like. As illustrated in the FIG. 2B, content items 222-4, 222-5, and/or 222-6 may relate to food, and advertisement 224-2, which may have been selected based on contextual information associated with content items 222-4, 222-5, and/or 222-6, may also relate to food. According to certain aspects, rather than obtain advertisement contextual parameters and information associated with the actual content items, cached content items may be utilized as an approximation of content items 222-4, 222-5, and/or 222-6, and the advertisement contextual parameters provided to the trained DNN may have included information associated with the cached content items.

Advertisement contextual parameters may also include information associated with each candidate advertisement, such as content information, format information, and the like. For example, the advertisement contextual parameters may include one or more embedding vectors associated with each content item 222-4, 222-5, and/or 222-6 (or a cached approximation thereof), which may represent certain aspects (e.g., content type, content category, image information, source/location information, content/image features, metadata associated with the content item, etc.) of each corresponding content item 222-4, 222-5, and/or 222-6 (or a cached approximation thereof), one or more embedding vectors associated with advertisement 224-1, which may represent certain aspects (e.g., advertisement type, advertisement category, advertisement format, advertisement image information, source/location information, advertisement/image features, metadata associated with the advertisement item, etc.) of advertisement 224-1. Further, the advertisement contextual parameters may also include embedding vectors associated with each candidate advertisement, which may represent certain aspects (e.g., content type, content category, image information, source/location information, metadata associated with the content item, etc.) of each corresponding candidate advertisement. According to certain aspects of the present disclosure, the embedding vectors associated with content items 222-4, 222-5, and/or 222-6 (or cached approximations thereof) and/or advertisement 224-1 may be compared with the embedding vectors of each candidate advertisement to determine a similarity metric between the surrounding non-advertisement content items (e.g., content items 222-4, 222-5, and/or 222-6, or cached approximations thereof) and/or advertisement 224-1 and each candidate advertisement. For example, the similarity metric may be determined (e.g., averaging the vectors, utilizing a max pooling algorithm, utilizing a cosine similarity algorithm, utilizing a clustering algorithm, etc.), and the similarity metric may be provided as an input to the second component/tower of the trained DNN to determine a predicted advertisement contextual relevance score associated with each candidate advertisement.

After the predicted advertisement quality relevance score and the predicted advertisement contextual relevance score may have been determined, the two relevance scores may be combined and/or aggregated to determine a predicted overall advertisement engagement score for determining and/or selecting advertisements 224-1 and 224-2. For example, a Sigmoid function may have been applied to the combination of the predicted advertisement quality relevance score and the predicted advertisement contextual relevance score to determine the predicted overall advertisement engagement score for each candidate advertisement. The predicted overall advertisement engagement score may represent a relevance of the advertisement and/or a likelihood that the user will engage with the advertisement, and may include a predicted click-through rate, revenue per recipient, or other metric based on both the advertisement quality information and the localized contextual information. Accordingly, advertisement 224-1 may correspond to the candidate advertisement with the highest predicted overall advertisement engagement score for the position at which advertisement 224-1 is presented, and advertisement 224-2 may correspond to the candidate advertisement with the highest predicted overall advertisement engagement score for the position at which advertisement 224-2 is presented.

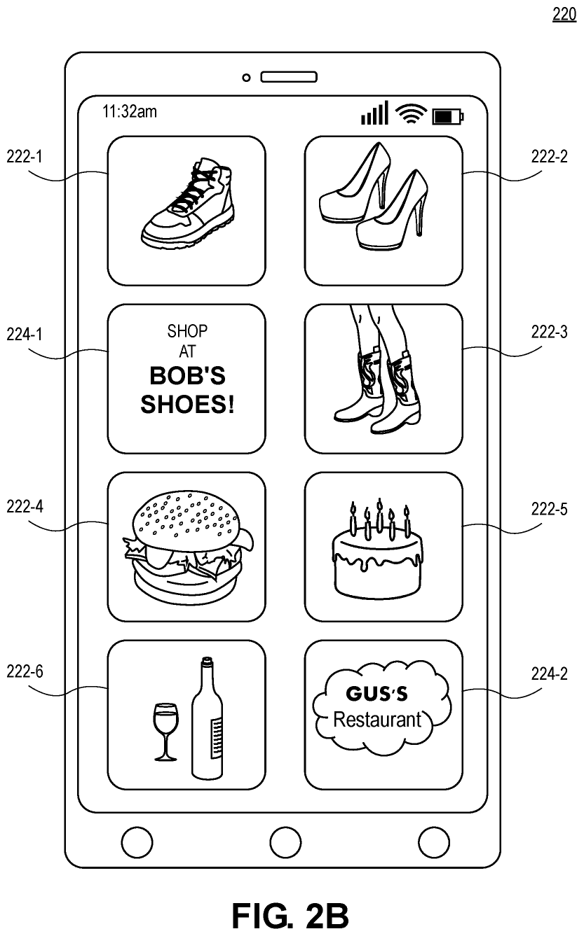

FIG. 3 is a block diagram of an exemplary advertisement determination model 300, according to exemplary embodiments of the present disclosure. Advertisement determination model 300 may represent one implementation of advertisement determination service 125, shown in FIG. 1.

As shown in FIG. 3, advertisement determination model 300 may include advertisement quality model 302, advertisement contextual model 304, and aggregation function 306. According to exemplary implementations, advertisement determination model 300 may include one or more DNNs, or other machine learning models. As illustrated in FIG. 3, advertisement determination model 300 may include a DNN with two independent components/towers. Accordingly, the first component/tower of the DNN may be advertisement quality model 302, and the second component/tower of the DNN may be advertisement contextual model 304.

In connection with a request for advertisements, advertisement determination model 300 may obtain as inputs advertisement quality parameters 312 and advertisement contextual parameters 314. Advertisement quality parameters 312 may be processed by advertisement quality model 302 to determine an advertisement quality relevance score for each candidate advertisement. Additionally, advertisement contextual parameters 314 may be processed by advertisement contextual model 304 to determine an advertisement contextual relevance score for each candidate advertisement. Next, advertisement quality relevance score and the advertisement contextual relevance score may be aggregated by aggregation function 306 to determine and output an overall advertisement engagement score. According to aspects of the present disclosure, each of the advertisement quality relevance score, the advertisement contextual relevance score, and the overall advertisement engagement score may include a predicted anticipated click-through rate, revenue per recipient, other metrics, and the like. Accordingly, the overall advertisement engagement score can be utilized to determine which of the candidate advertisements to be presented in response to the request for advertisements received by advertisement determination model 300.

In exemplary implementations, advertisement quality parameters 312 may be provided as an input to advertisement quality model 302 to determine an advertisement quality relevance score for each candidate advertisement and may include information, parameters, and data associated with the user to whom the advertisement will be presented. For example, advertisement quality parameters 312 may include information such as user profile information, user preferences, user browsing history, user tastes, user likes/dislikes, content items associated with the user, demographic information, user activity, user subscriptions, queries performed by the user, and the like. Advertisement quality parameters 312 may be provided as inputs to advertisement determination model 300 in the form of one or more embedding vectors associated with the user.

Additionally, advertisement contextual parameters 314 may be provided as an input to advertisement contextual model 304 to determine an advertisement contextual relevance score for each candidate advertisement, and may include information, parameters, and data associated with the position of the advertisement to be presented (e.g., slot, column, etc.), information regarding the non-advertisement content surrounding and/or in close proximity of the advertisement to be presented, information regarding the advertisement content surrounding and/or in close proximity of the advertisement to be presented, information regarding the content of the candidate advertisement, and the like. Advertisement contextual parameters 314 may also include information associated with each candidate advertisement, such as content information, format information, and the like.

For example, advertisement contextual parameters 314 may include one or more embedding vectors associated with non-advertisement content items surrounding and/or in proximity to the predefined ad position for which an advertisement is being selected. The embedding vectors may represent certain aspects (e.g., content type, content category, image information, source/location information, content/image features, metadata associated with the content item, etc.) of each surrounding non-advertisement content item, one or more embedding vectors associated with the advertisement surrounding and/or presented in proximity to the predefined ad position for which an advertisement is being selected. These embedding vectors may also represent certain aspects (e.g., advertisement type, advertisement category, advertisement format, advertisement image information, source/location information, advertisement/image features, metadata associated with the advertisement item, etc.) of the advertisement presented in proximity to the predefined ad position for which an advertisement is being selected. Further, the advertisement contextual parameters may also include embedding vectors associated with each candidate advertisement, which may represent certain aspects (e.g., content type, content category, image information, source/location information, metadata associated with the content item, etc.) of each corresponding candidate advertisement. According to certain aspects of the present disclosure, the embedding vectors associated with the surrounding non-advertisement content items and/or the surrounding advertisements may be compared with the embedding vectors of each candidate advertisement to determine a similarity metric between the surrounding non-advertisement content items and/or the surrounding advertisements and each candidate advertisement. For example, the similarity metric may be determined (e.g., averaging the vectors, utilizing a max pooling algorithm, utilizing a cosine similarity algorithm, utilizing a clustering algorithm, etc.), and the similarity metric may be provided as an input to advertisement contextual model 304 to determine an advertisement contextual relevance score associated with each candidate advertisement.

As shown in FIG. 3, the advertisement quality relevance score and the advertisement contextual relevance score may be provided to aggregation function 306, which may combine and/or aggregate the advertisement quality relevance score and the advertisement contextual relevance score to determine an overall advertisement engagement score for each candidate advertisement. For example, a Sigmoid function may be applied to the combination of the advertisement quality relevance score and the advertisement contextual relevance score to determine the overall advertisement engagement score for each candidate advertisement. The overall advertisement engagement score may represent a predicted click-through rate, revenue per recipient, or other metric based on both the advertisement quality information and the localized contextual information. Accordingly, the candidate advertisement with the highest overall advertisement engagement score for each predefined ad position may be selected for presentation at the respective predefined ad position.

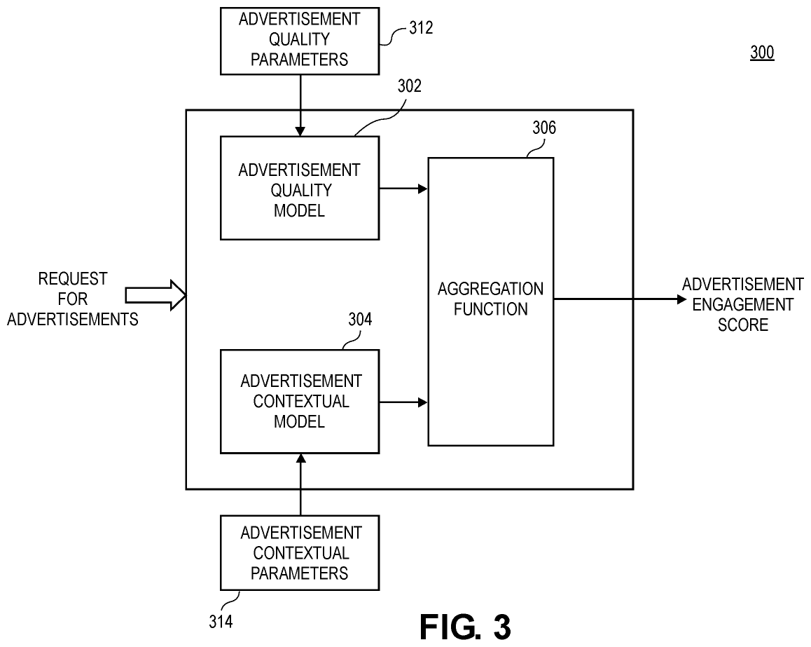

FIG. 4 is a flow diagram of an exemplary training process 400 for training a DNN (or other machine learning model), according to exemplary embodiments of the present disclosure.

As shown in FIG. 4, training process 400 is configured to train an untrained DNN 434 operating on computer system 440 to transform untrained DNN 434 into trained DNN 436 that operates on the same or another computer system, such as remote computing resource 120. In the course of training, as shown in FIG. 4, at step 402, untrained DNN 434 is initialized with training criteria 430. Training criteria 430 may include, but is not limited to, information as to a type of training, and number of layers to be trained, etc. According to embodiments of the present disclosure, trained DNN 436 may be trained to include two independent components/towers in a single trained DNN 436. Accordingly, the two components/towers of trained DNN 436 may be co-trained together in a single trained DNN 436.

At step 404 of training process 400, corpus of training data 432, may be accessed. For example, if training is to generate a trained DNN that predicts advertisement relevance scores, training data 432 may include advertisement quality associated data such as user profile information, user preferences, user browsing history, user tastes, user likes/dislikes, content items associated with the user, demographic information, user activity, user subscriptions, queries performed by the user, and the like, as well as advertisement contextual data, such as data associated with the position of the advertisement to be presented (e.g., slot, column, etc.), information regarding the non-advertisement content surrounding and/or in close proximity of the advertisement to be presented (e.g., embedding vectors, etc.), information regarding the advertisement content surrounding and/or in close proximity of the advertisement to be presented (e.g., embedding vectors, etc.), information regarding the content of the candidate advertisement (e.g., embedding vectors, etc.), and the like.

With training data 432 accessed, at step 406, training data 432 is divided into training and validation sets. Generally speaking, the items of data in the training set are used to train untrained DNN 434 and the items of data in the validation set are used to validate the training of the DNN. As those skilled in the art will appreciate, and as described below in regard to much of the remainder of training process 400, there are numerous iterations of training and validation that occur during the training of the DNN.

At step 408 of training process 400, the data items of the training set are processed, often in an iterative manner. Processing the data items of the training set include capturing the processed results. After processing the items of the training set, at step 410, the aggregated results of processing the training set are evaluated, and at step 412, a determination is made as to whether a desired accuracy level has been achieved. If the desired accuracy level is not achieved, in step 414, aspects of the machine learning model are updated in an effort to guide the machine learning model to generate more accurate results, and processing returns to step 406, where a new set of training data is selected, and the process repeats. Alternatively, if the desired accuracy level is achieved, training process 400 advances to step 416.

At step 416, and much like step 408, the data items of the validation set are processed, and at step 418, the processing accuracy of this validation set is aggregated and evaluated. At step 420, a determination is made as to whether a desired accuracy level, in processing the validation set, has been achieved. If the desired accuracy level is not achieved, in step 414, aspects of the machine learning model are updated in an effort to guide the machine learning model to generate more accurate results, and processing returns to step 406. Alternatively, if the desired accuracy level is achieved, the training process 400 advances to step 422.

At step 422, the two independent components/towers of the DNN are split, and at step 424, a finalized, trained DNN 436 is generated. Typically, though not exclusively, as part of finalizing the now-trained DNN 436, portions of the DNN that are included in the model during training for training purposes are extracted, thereby generating a more efficient trained DNN 436.

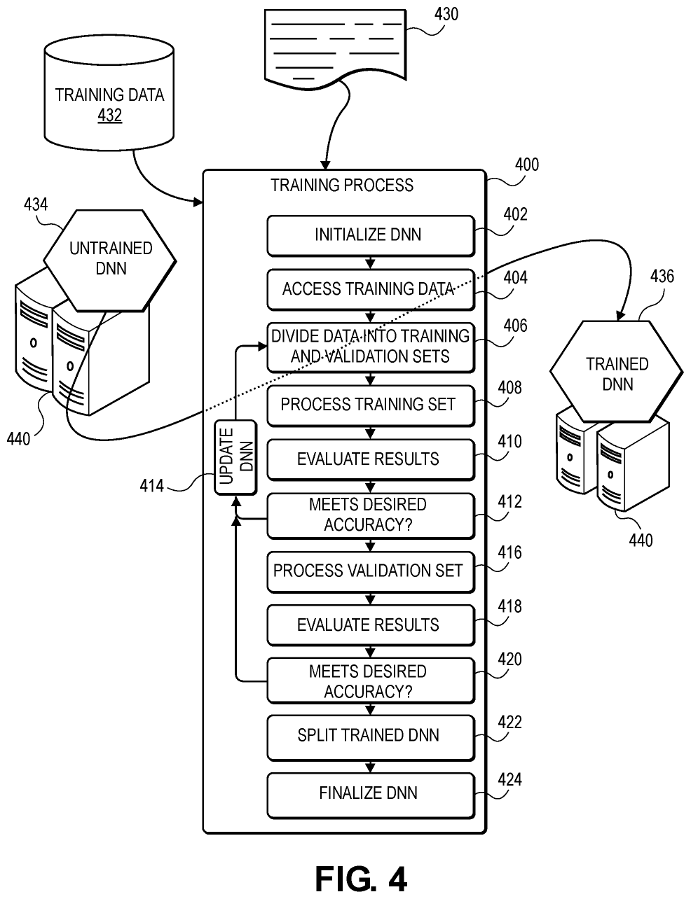

FIG. 5 is a flow diagram of an exemplary advertisement determination process 500, according to exemplary embodiments of the present disclosure.

As shown in FIG. 5, process 500 may begin with a request for one or more advertisements, as in step 502. The request for advertisements may be obtained, for example, in connection with a user who is making a query, navigating, viewing, accessing, and/or otherwise consuming content items as part of a social media platform or environment, a networking platform or environment, an e-commerce platform or environment, or through any other form of interactive computing. In response to the request for advertisements, in step 504, available candidate advertisements may be obtained. For example, the advertisements may be available candidate advertisements that are available for presentation to the user in connection with the request for advertisements and may be obtained from a data store (e.g., candidate advertisement data store 160).

In step 506, advertisement quality parameters may be obtained. For example, the advertisement quality parameters may include information such as a query submitted by the user, user profile information, user preferences, user browsing history, user tastes, user likes/dislikes, content items associated with the user, demographic information, user activity, user subscriptions, queries performed by the user, and the like. The advertisement quality parameters can be provided as an input to a trained DNN, which can process the advertisement quality parameters to determine an advertisement quality relevance score for each candidate advertisement, as in step 508. The predicted advertisement quality relevance score may represent a predicted click-through rate, revenue per recipient, or other metric based on the user information.

In step 510, advertisement contextual parameters may be obtained. For example, the advertisement contextual parameters may include information such as the position of the advertisement to be presented, information regarding the non-advertisement content surrounding and/or in close proximity of the advertisement to be presented, information regarding the advertisement content surrounding and/or in close proximity of the advertisement to be presented, information regarding the content of the candidate advertisement, and the like. According to certain aspects, rather than obtain advertisement contextual parameters and information associated with the actual non-advertisement content items, cached content items may be utilized as an approximation of the non-advertisement content so as to reduce latency issues, and the advertisement contextual parameters provided to the trained DNN may include information associated with the cached non-advertisement content items. Additionally, the advertisement contextual parameters may include a similarity metric representing a similarity between the surrounding non-advertisement content items and/or the surrounding advertisements and each candidate advertisement. For example, the similarity metric may be determined based on embedding vectors associated with the surrounding non-advertisement content items and/or the surrounding advertisements and each candidate advertisement. For example, the similarity metric may be determined (e.g., averaging the vectors, utilizing a max pooling algorithm, utilizing a cosine similarity algorithm, utilizing a clustering algorithm, etc.).

The advertisement contextual parameters can also be provided to the trained DNN, which can process the advertisement contextual parameters to determine an advertisement contextual relevance score for each candidate advertisement, as in step 512. The advertisement contextual relevance score may represent a predicted click-through rate, revenue per recipient, or other metric based on the localized contextual information.

In step 514, the advertisement quality relevance score and the advertisement contextual relevance score may be combined and/or aggregated to determine an overall advertisement engagement score for each candidate advertisement. For example, a Sigmoid function may be applied to the combination of the predicted advertisement quality relevance score and the predicted advertisement contextual relevance score to determine the predicted overall advertisement engagement score for each candidate advertisement. The overall advertisement engagement score may represent a relevance and/or a likelihood of user engagement with the advertisement, and may include a predicted click-through rate, revenue per recipient, or other metric based on both the advertisement quality information and the localized contextual information, and may be used to determine the candidate advertisement to present to the user, as in step 516. For example, the candidate advertisements with the highest overall advertisement engagement score may be selected as the advertisement to be presented to the user.

Optionally, after the advertisements have been determined and presented to the user, the performance of the presented advertisements may be obtained, as in step 518. For example, click through rates associated with each advertisement may be determined, and in step 520, based on the tracked performance (e.g., click through rates), feedback training data may be generated to continuously update the trained DNN to improve the performance and accuracy of the trained DNN.

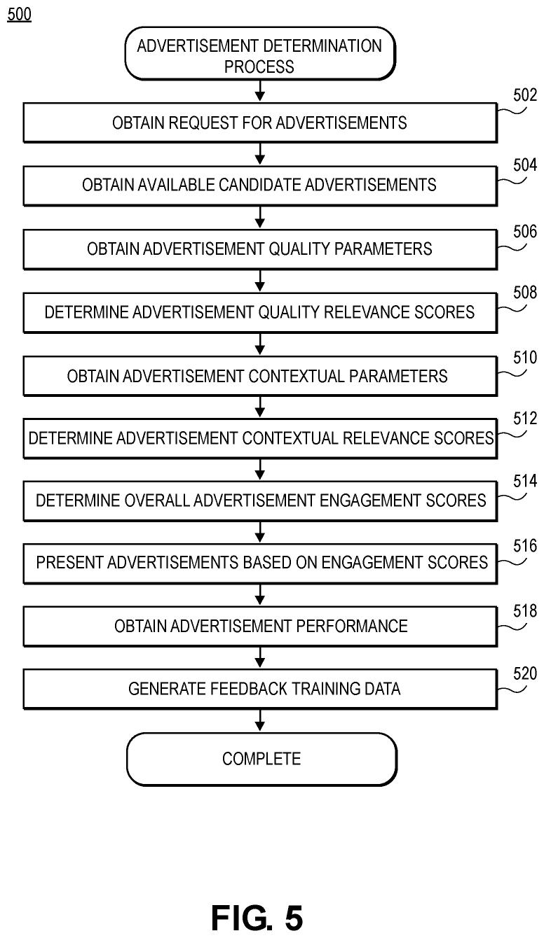

FIG. 6 is a flow diagram of an exemplary DNN update process 600, according to exemplary embodiments of the present disclosure.

As discussed above, in some implementations, the DNN used to determine advertisements may be continually or periodically updated as performance of the presented advertisements are tracked and/or monitored. Process 600 may begin by initially training a DNN to determine advertisements for presentation to a user, as in step 602. This is described in further detail herein in connection with FIG. 4.

At some point after the DNN is initially trained, the performance of one or more advertisements may be obtained (e.g., based on user interactions with the advertisements—click through rates, revenue per response, etc.), as in 604.

The performance of the one or more advertisements may be utilized to generate feedback training data, which may be used to update the DNN, as in 606.

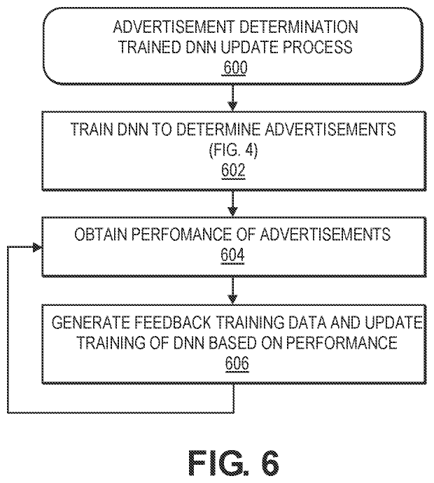

FIG. 7 illustrates an exemplary client device 700 that can be used in accordance with various implementations described herein. In this example, client device 700 includes display 702 and optionally at least one input component 704, such as a camera, on a same side and/or opposite side of the device as display 702. Client device 700 may also include an audio transducer, such as speaker 706, and microphone 708. Generally, client device 700 may have any form of input/output components that allow a user to interact with client device 700. For example, the various input components for enabling user interaction with the device may include touch-based display 702 (e.g., resistive, capacitive, Interpolating Force-Sensitive Resistance (IFSR)), camera (for gesture tracking, etc.), microphone, global positioning system (GPS), compass or any combination thereof. One or more of these input components may be included on a user device or otherwise in communication with the user device. Various other input components and combinations of input components can be used as well within the scope of the various implementations, as should be apparent in light of the teachings and suggestions contained herein.

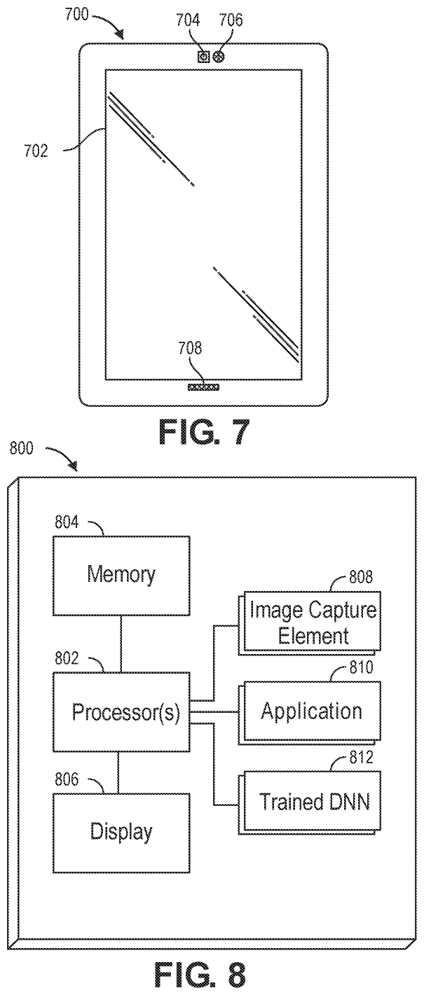

In order to provide the various functionality described herein, FIG. 8 illustrates an exemplary set of components 800 of client device 700, such as client device 700 described with respect to FIG. 7 and discussed herein. In this example, the device includes at least one central processor 802 for executing instructions that can be stored in at least one memory device or element 804. As would be apparent to one of ordinary skill in the art, the device can include many types of memory, data storage or computer-readable storage media, such as a first data storage for program instructions for execution by the one or more processors 802. Removable storage memory can be available for sharing information with other devices, etc. The device typically will include some type of display 806, such as a touch-based display, electronic ink (e-ink), organic light emitting diode (OLED), liquid crystal display (LCD), etc.

As discussed, the device in many implementations will include at least one image capture element 808, such as one or more cameras that are able to image objects in the vicinity of the device. An image capture element can include, or be based at least in part upon, any appropriate technology, such as a CCD or CMOS image capture element having a determined resolution, focal range, viewable area, and capture rate. The device can include at least one application component 810 for performing the implementations discussed herein. Optionally, the device can include trained DNN 812, which can be configured to determine advertisements for presentation to a user according to the implementations described herein. The user device may be in constant or intermittent communication with one or more remote computing resources and may exchange information, such as livestream feeds, chat messages, etc., with the remote computing system(s) as part of the disclosed implementations.

The device also can include at least one location component, such as GPS, NFC location tracking, Wi-Fi location monitoring, etc. The example client may also include at least one additional input device able to receive conventional input from a user. This conventional input can include, for example, a push button, touch pad, touch-based display, wheel, joystick, keyboard, mouse, trackball, keypad or any other such device or element whereby a user can submit an input to the device. These I/O devices could be connected by a wireless, infrared, Bluetooth, or other link as well in some implementations. In some implementations, however, such a device might not include any buttons at all and might be controlled only through touch inputs (e.g., touch-based display), audio inputs (e.g., spoken), or a combination thereof.

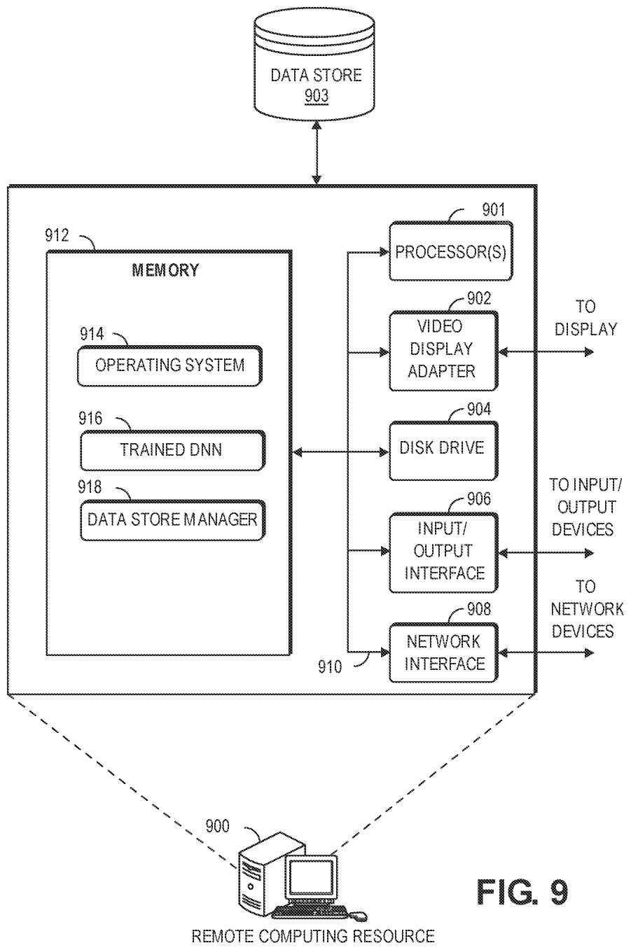

FIG. 9 is a pictorial diagram of an illustrative implementation remote computing resource 900 that may be used with one or more of the implementations described herein. Remote computing resource 900 may include one or more processors 901, such as one or more redundant processors, video display adapter 902, disk drive 904, input/output interface 906, network interface 908, and memory 912. Processor(s) 901, video display adapter 902, disk drive 904, input/output interface 906, network interface 908, and memory 912 may be communicatively coupled to each other by communication bus 910.

Video display adapter 902 provides display signals to a local display permitting an operator of remote computing resource 900 to monitor and configure operation of remote computing resource 900. Input/output interface 906 likewise communicates with external input/output devices not shown in FIG. 9, such as a mouse, keyboard, scanner, or other input and output devices that can be operated by an operator of remote computing resource 900. Network interface 908 includes hardware, software, or any combination thereof, to communicate with other computing devices. For example, network interface 908 may be configured to provide communications between remote computing resource 900 and other computing devices, such as client device 700.

Memory 912 generally comprises random access memory (RAM), read-only memory (ROM), flash memory, and/or other volatile or permanent memory. Memory 912 is shown storing operating system 914 for controlling the operation of remote computing resource 900. Remote computing resource 900 may also include trained DNN 916, as discussed herein. In some implementations, trained DNN 916 may determine advertisements to be presented to a user at predefined ad positions. In other implementations, trained DNN 916 may exist on both remote computing resource 900 and/or each client device (e.g., DNN 812).

Memory 912 additionally stores program code and data for providing network services that allow client devices 110 and external sources to exchange information and data files with remote computing resource 900. Memory 912 may also include interactive trained DNN 916, which may communicate with data store manager application 918 to facilitate data exchange and mapping between the data store 903, user/client devices, such as client devices 110, external sources, etc.

As used herein, the term “data store” refers to any device or combination of devices capable of storing, accessing and retrieving data, which may include any combination and number of data servers, databases, data storage devices and data storage media, in any standard, distributed or clustered environment. Remote computing resource 900 can include any appropriate hardware and software for integrating with the data store 903 as needed to execute aspects of one or more applications for the client device 700, the external sources, etc.

Data store 903 can include several separate data tables, databases or other data storage mechanisms and media for storing data relating to a particular aspect. For example, data store 903 as illustrated includes digital items (e.g., images) and corresponding metadata (e.g., image segments, popularity, source) about those items. Participant/attendee, host information and/or other information may likewise be stored in the data store.

It should be understood that there can be many other aspects that may be stored in data store 903, which can be stored in any of the above listed mechanisms as appropriate or in additional mechanisms of any of the data store. Data store 903 may be operable, through logic associated therewith, to receive instructions from remote computing resource 900 and obtain, update or otherwise process data in response thereto.

Remote computing resource 900, in one implementation, is a distributed environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 9. Thus, the depiction in FIG. 9 should be taken as being illustrative in nature and not limiting to the scope of the disclosure.

Aspects of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage media may be implemented by a volatile computer memory, non-volatile computer memory, hard drive, solid-state memory, flash drive, removable disk, and/or other media. In addition, components of one or more of the modules and engines may be implemented in firmware or hardware.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the field of computers, communications, media files, and machine learning should recognize that components and process steps described herein may be interchangeable with other components or steps, or combinations of components or steps, and still achieve the benefits and advantages of the present disclosure. Moreover, it should be apparent to one skilled in the art that the disclosure may be practiced without some, or all of the specific details and steps disclosed herein.

Moreover, with respect to the one or more methods or processes of the present disclosure shown or described herein, including but not limited to the flow charts shown in FIGS. 4-6, orders in which such methods or processes are presented are not intended to be construed as any limitation on the claims, and any number of the method or process steps or boxes described herein can be combined in any order and/or in parallel to implement the methods or processes described herein. In addition, some process steps or boxes may be optional. Also, the drawings herein are not drawn to scale.

Aspects of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage media may be implemented by a volatile computer memory, non-volatile computer memory, hard drive, solid-state memory, flash drive, removable disk, and/or other media. In addition, components of one or more of the modules and engines may be implemented in firmware or hardware.

Disjunctive language such as the phrase “at least one of X, Y, or Z,” or “at least one of X, Y and Z,” unless specifically stated otherwise, is otherwise understood with the context as used in general to present that an item, term, etc., may be any of X, Y, or Z, or any combination thereof (e.g., X, Y, and/or Z). Thus, such disjunctive language is not generally intended to, and should not, imply that certain implementations require at least one of X, at least one of Y, or at least one of Z to each be present.

Unless otherwise explicitly stated, articles such as “a” or “an” should generally be interpreted to include one or more described items. Accordingly, phrases such as “a device configured to” or “a device operable to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Language of degree used herein, such as the terms “about,” “approximately,” “generally,” “nearly” or “substantially” as used herein, represent a value, amount, or characteristic close to the stated value, amount, or characteristic that still performs a desired function or achieves a desired result. For example, the terms “about,” “approximately,” “generally,” “nearly” or “substantially” may refer to an amount that is within less than 10% of, within less than 5% of, within less than 1% of, within less than 0.1% of, and within less than 0.01% of the stated amount.

Conditional language, such as, among others, “can,” “could,” “might,” or “may,” unless specifically stated otherwise, or otherwise understood within the context as used, is generally intended to convey in a permissive manner that certain implementations could include, or have the potential to include, but do not mandate or require, certain features, elements and/or steps. In a similar manner, terms such as “include,” “including” and “includes” are generally intended to mean “including, but not limited to.” Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

Although the invention has been described and illustrated with respect to illustrative implementations thereof, the foregoing and various other additions and omissions may be made therein and thereto without departing from the spirit and scope of the present disclosure.

What is claimed is:

1. A computer-implemented method, comprising:
obtaining, in connection with a request for an advertisement, a plurality of candidate advertisements;
obtaining, in connection with the request, a plurality of advertisement quality parameters;
obtaining, in connection with the request, a plurality of advertisement contextual parameters;
for each of the plurality of candidate advertisements:
processing, using a trained deep neural network (DNN), at least a portion of the plurality of advertisement quality parameters to generate a predicted advertisement quality relevance score for the candidate advertisement;
processing, using the trained DNN, at least a portion of the plurality of advertisement contextual parameters to generate a predicted advertisement contextual relevance score for the candidate advertisements;
aggregating the predicted advertisement quality relevance score and predicted advertisement contextual relevance score to generate a predicted overall advertisement engagement score for the candidate advertisement;
determining, based at least in part on the predicted overall advertisement engagement scores for each of the plurality of candidate advertisements, a first advertisement from the plurality of candidate advertisements to be provided in response to the request.

2. The computer-implemented method of claim 1, wherein aggregating the predicted advertisement quality relevance score and predicted advertisement contextual relevance score to generate the predicted overall advertisement engagement score includes applying a Sigmoid function.

3. The computer-implemented method of claim 1, wherein the plurality of advertisement contextual parameters includes at least one of:
a first parameter associated with a position at which the advertisement is to be presented;
a second parameter associated with non-advertisement content that is to be presented proximate to the position;
a third parameter associated with advertisement content that is to be presented proximate to the position; or
a fourth parameter associated with a format of each of the plurality of candidate advertisements.

4. The computer-implemented method of claim 3, wherein the plurality of advertisement contextual parameters includes image information associated with the non-advertisement content that is to be presented proximate to the position.

5. The computer-implemented method of claim 3, wherein the second parameter associated with the non-advertisement content includes a similarity metric representing a similarity between the non-advertisement content and each of the plurality of candidate advertisements.

6. The computer-implemented method of claim 1, where the predicted advertisement quality relevance score is determined by a first component of the DNN and the predicted advertisement contextual relevance score is determined by a second component of the DNN.

7. A computing system, comprising:
one or more processors;
a memory storing program instructions that, when executed by the one or more processors, cause the one or more processors to at least:
obtain, in connection with a request for an advertisement, a candidate advertisement;
obtain, in connection with the request, a plurality of advertisement contextual parameters, the plurality of advertisement contextual parameters including a position at which the advertisement is to be presented in a user interface, and a similarity metric representing an image similarity between the candidate advertisement and non-advertisement content presented proximate to the position in the user interface;
process, using a trained deep neural network (DNN), at least a portion of the plurality of advertisement contextual parameters to determine a predicted advertisement contextual relevance score for the candidate advertisement;
determine, based at least in part on the predicted advertisement contextual relevance score, that the candidate advertisement is to be provided in response to the request.

8. The computing system of claim 7, wherein the program instructions, that when executed by the one or more processors, further cause the one or more processors to at least:
obtain a predicted advertisement quality relevance score for the candidate advertisement; and
aggregate the predicted advertisement quality relevance score and predicted advertisement contextual relevance score to generate a predicted overall advertisement engagement score for the candidate advertisement,
wherein the determination that the candidate advertisement is to be provided in response to the request is based at least in part on the predicted overall advertisement engagement score for the candidate advertisement.

9. The computing system of claim 8, wherein the predicted overall advertisement engagement score includes at least one of a predicted click-through rate or a predicted revenue per response.

10. The computing system of claim 8, wherein the predicted advertisement quality relevance score and predicted advertisement contextual relevance score are aggregated using a Sigmoid function to generate the predicted overall advertisement engagement score for the candidate advertisement.

11. The computing system of claim 8, wherein the program instructions, that when executed by the one or more processors, further cause the one or more processors to at least:
obtain a plurality of advertisement quality parameters, and
wherein the predicted advertisement quality relevance score is determined using the trained DNN to process at least a portion of the plurality of advertisement quality parameters.

12. The computing system of claim 11, wherein the predicted advertisement quality relevance score is determined by a first component of the DNN and the predicted advertisement contextual relevance score is determined by a second component of the DNN.

13. The computing system of claim 12, wherein the first component of the DNN and the second component of the DNN are co-trained together as a single model.

14. The computing system of claim 7, wherein the plurality of advertisement contextual parameters further includes at least one of:
a first parameter associated with advertisement content that is to be presented proximate to the position in the user interface; or
a second parameter associated with a format of the candidate advertisement.

15. The computing system of claim 7, wherein the non-advertisement content includes at least one cached non-advertisement content representing an approximation of non-advertisement content that is to be presented proximate to the position in the user interface.

16. A method, comprising:
obtaining, in connection with a request for an advertisement, a plurality of candidate advertisements;
obtaining, in connection with the request, a plurality of advertisement contextual parameters, the plurality of advertisement contextual parameters including a position at which the advertisement is to be presented in a user interface, and a similarity metric representing an image similarity between each of the plurality of candidate advertisements and non-advertisement content presented proximate to the position in the user interface;
for each of the plurality of candidate advertisements:
obtaining a predicted advertisement quality relevance score for the candidate advertisement;
processing, using a first component of a trained deep neural network (DNN), at least a portion of the plurality of advertisement contextual parameters to generate a predicted advertisement contextual relevance score for the candidate advertisements;
aggregating the predicted advertisement quality relevance score and predicted advertisement contextual relevance score to generate a predicted overall advertisement engagement score for the candidate advertisement;
determining, based at least in part on the predicted overall advertisement engagement scores for each of the plurality of candidate advertisements, a first advertisement from the plurality of candidate advertisements to be provided in response to the request.

17. The method of claim 16, wherein the plurality of advertisement contextual parameters further includes at least one of:
a first parameter associated with advertisement content that is to be presented proximate to the position in the user interface; or
a second parameter associated with a format of the candidate advertisement.

18. The method of claim 16, further comprising:
obtaining a plurality of advertisement quality parameters, and
processing at least a portion of the plurality of advertisement quality parameters using a second component of the trained DNN to generate the predicted advertisement quality relevance score for each of the plurality of candidate advertisements.

19. The method of claim 16, wherein the predicted overall advertisement engagement score includes at least one of a predicted click-through rate or a predicted revenue per response.

20. The method of claim 16, further comprising:
monitoring an actual performance associated with a presentation of the first advertisement;
generating, based at least in part on the actual performance associated with the presentation of the first advertisement, feedback training data; and
providing the feedback training data as a training input to update the DNN.
